(19) United States
(12) Patent Application Publication
(10) Pub. No.: US 2003/0192857 A1
(43) Pub. Date: Oct. 16, 2003

(54) Method of etching and apparatus for doing same

(75) Inventors: Noriiki Masuda, Yamanashi (JP); Manabu Sato, Yamanashi (JP)

Correspondence Address: Finnegan, Henderson, Farabow,, Garrett & Dunner, L.L.P., 1300 I Street, N.W., Washington, DC, 20005-3315, US

(73) Assignee: TOKYO ELECTRON LIMITED

(21) Appl. No.: 10/411,147

(22) Filed: Apr. 11, 2003

(30) Foreign Application Priority Data
Apr. 12, 2002 (JP) JP2002-110884

(51) Int. Cl. C23F 1/00; C03C 25/68; C03C 15/00

(52) U.S. Cl. 216/67; 216/71; 156/345.46; 156/345.47

(57) ABSTRACT

When etching a stacked-film layer including a plurality of films made of different quality materials by means of a magnetron plasma etching method, a magnetic field angle θ at which the magnetic line of force 45 intersects the edge portion of a wafer surface approximately at right angles, is optimized and set to every sort of the film to be etched, thereby enabling good etching uniformity to be realized.

### BACKGROUND OF THE INVENTION

The present invention relates to a method of etching by making use of magnetron plasma and apparatus for doing the same.

The magnetron plasma etching method making use of magnetron plasma is well known as one of various etching methods used in the process of manufacturing electronic elements made of a semiconductor such as silicon and others. Generally, in this method, there is used a processing chamber in which a pair of upper and lower electrodes is arranged in parallel to oppose to each other. A semiconductor wafer (referred to just as “wafer” hereinafter) is set up on the lower electrode in a predetermined manner and a predetermined treatment gas is introduced into the processing chamber. After preparation of the wafer and treatment gas as described above, the predetermined high frequency power is applied between the above upper and lower electrodes, thereby the treatment gas being put in the plasmatic state. With this, the reactive ions in the plasma are accelerated by the electric field induced on the wafer surface, thereby coming to strike the wafer surface to cause the etching reaction over the wafer surface. At this time, if the magnetic field is applied in the direction intersecting the self-bias electric field as induced on the wafer surface, the drift motion of electrons in the plasma is caused by the Lorentz force.

In the magnetron plasma etching method as described above, it has been known well that uniformity of etching rate in the wafer surface (referred to as “etching uniformity” hereinafter) varies depending on the angle at which the magnetic lines of force are incident on the wafer surface. This angle is referred to as “magnetic field angle” hereinafter. Therefore, there has been proposed and executed a plasma etching method in which the etching is carried out by setting the magnetic field angle to be a predetermined value in order to obtain the better etching uniformity.

In the prior art method as mentioned above, however, after once setting the magnetic field angle at a certain value, a series of the etching treatment was carried out without changing the value as set initially, that is, by using such a fixed magnetic field angle. Even when etching a stacked-film layer including a plurality of films made of different qualities of materials, the magnetic field angle was selected without carefully taking account of the difference in the quality of the material of each film. Especially, when etching a hard mask made up of a plurality of films made of different qualities of materials, as the thickness of each film is thin, the hard mask was etched at a time without changing the treatment conditions such as the etching gas, the inside pressure of the processing chamber, the magnetic field angle and so forth.

Actually, however, the magnetic field angle giving the most suitable etching uniformity varies corresponding to the quality of the film to be etched (film surface to be treated). Consequently, if a stacked-film layer composed of a plurality of films made of different qualities of materials is etched without varying the magnetic field angle, in other words, with a certain fixed magnetic field angle, it is a matter of course that desirable better etching uniformity can not be obtained. This is one of problems still left in the prior art plasma etching method without being solved.

Now, it will be explained how the etching rate of the films made of different qualities of materials changes depending on the magnetic field angel by way of some concrete examples, with reference to FIGS. 9(A), 9(B), 10(A) and 10(B). These figures are graphs indicating the distribution of the etching rate on a thermally oxidized silicon dioxide (SiO₂) layer and the same on a silicon nitride (SiN) layer as well. The distributions of the etching rate as shown in FIGS. 9(A), 9(B) (referred to simply as FIG. 9 hereinafter when referring to both of them together) as well as in FIGS. 10(A), 10(B) (referred to simply as FIG. 10 hereinafter when referring to both of them together) have been obtained under the same condition as described in the following Treatment Condition 1, except the magnetic field angle. That is, in FIG. 9, the magnetic field angle is equally set at 12.88° (degree). FIG. 9(A) indicates the distribution of the etching rate on the thermally oxidized SiO₂ layer while FIG. 9(B) indicates the distribution of the etching rate on the SiN layer. On one hand, in FIG. 10, the magnetic field angle is equally set at 4.93°. FIG. 10(A) indicates the distribution of the etching rate on the thermally oxidized SiO₂ layer while FIG. 10(B) indicates the distribution of the etching rate on the SiN layer. The above magnetic field angle is an angle made by the magnetic line of force and the wafer surface at the edge portion of the wafer. In both of FIGS. 9 and 10, it is intended to indicate two values of etching rate actually obtained in two directions i.e. the X-Y directions perpendicularly intersecting each other on the wafer surface, but these tow values are shown as if they had a single value because two etching rate values coincide with each other very well.

[Treatment Condition 1]

Wafer diameter: 300 mm

High frequency power source: 3200 W

Gap between electrodes: 40 mm

Etching gas: CHF₃/CF₄/Ar/O₂=10/170/300/30 sccm

Pressure inside processing chamber: 50 mTorr

Susceptor temperature: 60° C.

As shown in FIG. 9, when the magnetic field angle is set at 12.88°, the distribution of the etching rate on the SiN layer in the direction of the wafer diameter becomes considerably uniform as shown in FIG. 9(b). Comparing with this, the etching rate in the peripheral portion of the thermally oxidized SiO₂ layer is smaller than that in the center portion of the same, thus the distribution of the etching rate coming to show a convex shape as shown in FIG. 9(a). On one hand, when the magnetic field angle is set at 4.93°, the distribution of the etching rate on the thermally oxidized SiO₂ layer is approximately uniform except small variations of the etching rate in the edge portion as shown in FIG. 10(a). Comparing with this, the etching rate in the peripheral portion of the SiN layer is larger than that in the center portion of the same, thus the distribution of the etching rate coming to show a concave shape as shown in FIG. 10(b). That is, the magnetic field angle giving good etching uniformity is 12.88° for the SiN layer and 4.93° for the thermally oxidized SiO₂ layer.

As will be understood from the above explanation, the magnetic field angle giving good etching uniformity takes completely different values depending on the quality of material constituting the film. Accordingly, it would be hardly possible to obtain good etching uniformity as far as a stacked-film layer including a plurality of films made of different qualities of materials is etched by using a fixed magnetic field angle as has been done in the prior art plasma etching method.

Accordingly, the present invention has been made in view of such problems as described above, and an object of the invention is to provide a method of etching a stacked-film layer, which is able to give good etching uniformity to every film of a stacked-film layer to be etched by using the magnetron plasma etching method.

### SUMMARY OF THE INVENTION

In order to solve the above-mentioned problems, according to the first aspect of the invention, there is provided a method of etching a stacked-film layer formed on a substrate and including a plurality of films made of materials having different qualities, including the steps of: generating such a magnetic field that makes a predetermined angle to the edge portion of the substrate mounted inside a processing chamber and is approximately in parallel with the surface of the substrate at the center portion thereof; applying a high frequency electric power for generating plasma to an electrode provided inside the processing chamber so as to generate a high frequency alternating electric field in the direction intersecting the surface of the substrate approximately at right angles, thereby making plasma of an etching gas introduced in the processing chamber and etching the stacked-film layer with the plasma; and setting the predetermined magnetic field angle to every sort of the film to be etched.

Furthermore, in order to solve the above-mentioned problems, according to the second aspect of the invention, there is provided apparatus for etching a stacked-film layer formed on a substrate and including a plurality of films made of materials having different qualities including: means for generating such a magnetic field that makes a predetermined angle to the edge portion of the substrate mounted inside a processing chamber and is approximately in parallel with the surface of the substrate at the center portion thereof; means for applying a high frequency electric power for generating plasma to an electrode provided inside the processing chamber so as to generate a high frequency alternating electric field in the direction intersecting the surface of the substrate approximately at right angles, thereby making plasma of an etching gas introduced in the processing chamber and etching the stacked-film layer with the plasma; and means for setting the predetermined magnetic field angle to every sort of the film to be etched.

According to the above first and second aspects of the invention, it becomes possible to set the most suitable magnetic field angle to every sort of the film to be etched, thus the good etching uniformity being obtained on the every sort of the film.

The etching of the above-mentioned stacked-film layer is preferably carried out in the same processing chamber without taking out the substrate. At least two films included in the stacked-film layer may be etched with the same sort of gas. The predetermine angle of the magnetic field may be in the range of 3° through 15°. The high frequency power source is preferably cut off while the predetermined angle of the magnetic field is being changed.

The stacked-film layer may include any one of at least silicon oxide film, silicon nitride film or silicon oxinitride film and further may include a film made of an organic material. At that time, the stacked-film layer may serve as a mask layer to the foundation layer while the foundation layer is etched,

### BRIEF DESCRIPTION OF THE DRAWINGS

FIG. 1 is a diagram schematically showing the constitution of a magnetron reactive ion etching apparatus.

FIG. 2 is a top view of a dipole ring magnet.

FIG. 3 is a sectional view of the dipole ring magnet.

FIG. 4 is a diagram showing an etching sample.

FIG. 5 is a graph indicating a distribution of taper angle after treatment by an etching method according to an embodiment of the invention.

FIG. 6 is a graph indicating a distribution of CD shift amount after treatment by an etching method according to an embodiment of the invention.

FIG. 7 is a graph indicating a distribution of taper angle after treatment by a prior art etching method.

FIG. 8 is a graph indicating a distribution of CD shift amount after treatment by a prior art etching method.

FIG. 9 is a graph indicating a distribution of etching rate.

FIG. 10 is a graph indicating a distribution of etching rate.

### DETAILED DESCRIPTION OF THE PREFERRED EMBODIMENTS

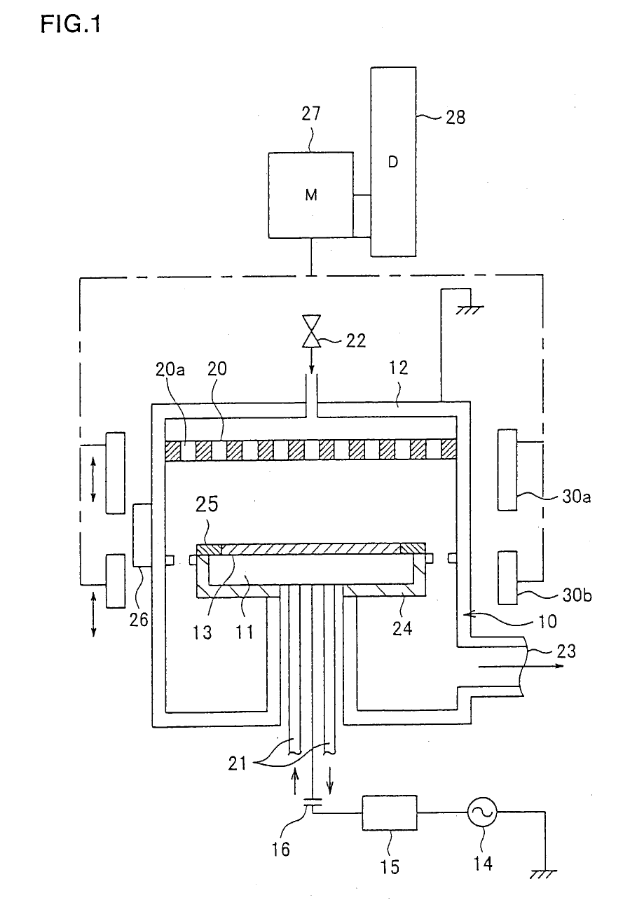

Preferred embodiments of an etching method according to the invention will now be described in the following with reference to the accompanying drawings. To begin with, there will be explained the constitution of a magnetron reactive ion etching (RIE) apparatus, with reference to FIG. 1, as an example of the apparatus capable of executing the etching method according to the invention.

The inside of an airtight treatment container 10 is equipped with necessary things for treatment, thus being referred to as a processing chamber hereinafter. In the processing chamber 10, there is arranged a lower side electrode (cathode) 11 on which an objective body to be treated such as a semiconductor wafer (referred to as “substrate” hereinafter) for instance a wafer 13 is mounted. The upper inside wall of the processing chamber 10 in parallel with the lower side electrode 11 works as an upper side electrode (anode) 12. A high frequency power source 14, serving as a means for applying a high frequency electric power, generates electric power of 13.56 MHz and supplies it between the lower side electrode 11 and the upper side electrode 12 via a matching circuit 15 and a condenser 16.

Two dipole ring magnets 30a, 30b, serving as a means for generating a magnetic field, are arranged in parallel at a predetermined interval in the direction of the vertical center axis of the processing chamber 10 so as to surround the circumference of the processing chamber 10. These dipole ring magnets 30a, 30b will be described in detail later. A motor 27 as shown in FIG. 1 is able to separately rotate each of dipole ring magnets 30a, 30b around the circumference of the processing chamber 10. Furthermore, a driving mechanism 28, serving as a means for setting the magnetic field angle, is able to separately move each of dipole magnets 30a, 30b in the up and down directions.

An opening bored in a part of the ceiling portion of the processing chamber 10 is the opening for introducing a reactive gas into the processing chamber 10 and is connected with a reactive gas supply system 22. The reactive gas supplied from the above supply system 22 passes through a lot of small ejection holes penetrating through a gas diffusion plate 22 to uniformly eject it over the surface of the wafer 13 to be treated. Furthermore, the lower portion of the processing chamber 10 is connected with an exhaust pipe 23 communicating with a vacuum mechanism (not shown) and the atmosphere inside the processing chamber 10 can be kept at a predetermined reduced pressure by operating the vacuum mechanism.

The lower side electrode 11 serving as a wafer supporting table has a piping 21 for cooling in its inside space and the wafer temperature can be efficiently controlled by supplying a cooling liquid through the piping 21. The side portion and the lower portion of the lower side electrode 11 are equipped with an insulator 24 to electrically isolate the electrode 11 from the external environment. A focus ring 25 is placed on the peripheral portion of the lower side electrode 11 to surround the periphery of the wafer mounted on and supported by the lower side electrode 11. The focus ring 25 may be made of various materials for instance ceramics such as silicon carbide (SiC), alumina (Al₂O₃), aluminum nitride (AlN), boron nitride (BN) and others, and further carbon having various structure, Si, organics, metals, alloys and others. These materials may be selected to meet the treatment condition such as a sort of the film to be etched, an etching gas and so forth. Putting the wafer into and taking it out from the processing chamber 10 are carried out making use of a gap space between the dipole ring magnets 30a, 30b by operating a load/lock mechanism as well as a transport mechanism via a gate valve 26

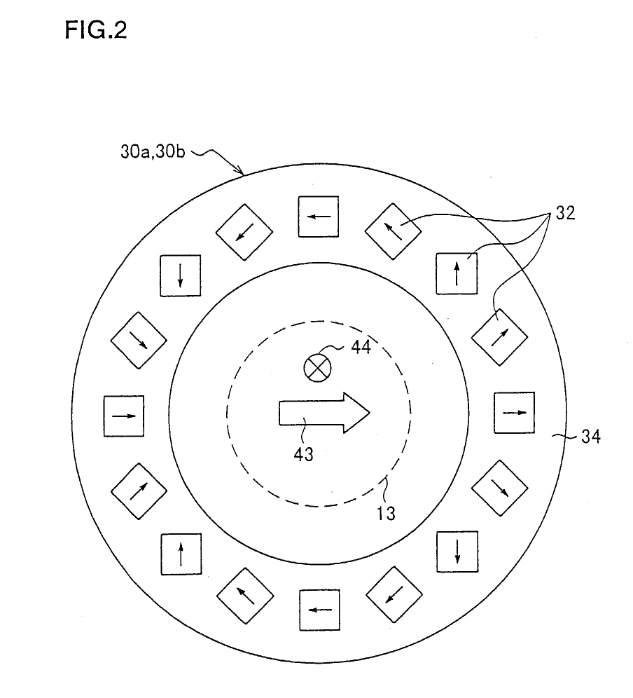

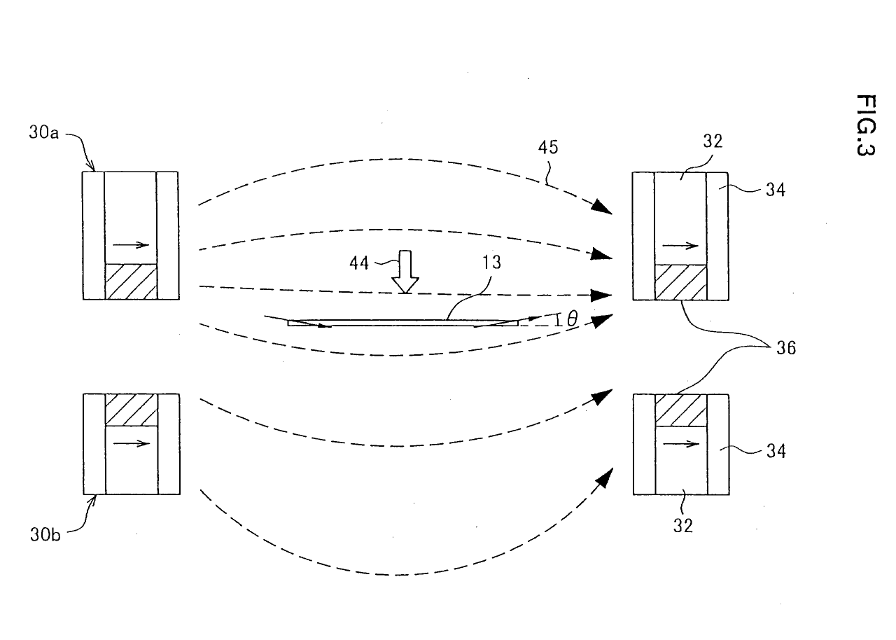

Here, the dipole ring magnets 30a, 30b will be explained with reference to FIGS. 2 and 3. FIG. 2 is a top view of a dipole ring magnets 30a, 30b while FIG. 3 is a sectional view of the same. Each of these dipole ring magnets 30a, 30b is made in the form of a ring and includes a plurality of anisotropic segmental magnets 32 put in a nonmagnetic holder 34. The number of anisotropic segmental magnets is preferably eight or more. Ordinarily, the number of segmental magnets is suitably selected in the range of 8 to 32. FIG. 2 indicates an example where 16 anisotropic segmental magnets 32 are put in the nonmagnetic holder 34.

The cross section of the anisotropic segmental magnet 32 may have an arbitrary shape, which is for instance circular, square, rectangular, trapezoidal and others. In the example as shown in FIG. 2, the segmental magnets 32 have the square shaped section. An arrow mark as put on the inside of each anisotropic segmental magnet 32 indicates the direction of magnetization. If segmental magnets 32 are arranged such that they direct to their magnetization directions as shown in FIG. 2, the magnetic field is generated within the ring and in the direction as shown by a large arrow mark 43.

The above magnetic field has a magnetic field intensity of 120 gauss at the surface center of the wafer 13 and the direction of the magnetic field is approximately in parallel with the surface of the wafer 13. In FIG. 2, the wafer 13 is indicated in the ring of the dipole ring magnets 30a, 30b. As shown in FIG. 3, a spacer 36 made of nonmagnetic material (aluminum or the like) is provided on the face where a plurality of segmental magnets 32 of the dipole ring magnet 30a and the same of the dipole ring magnet 30b oppose to each other.

With regard to the element of respective dipole ring magnets 30a, 30b, that is, the magnetization direction, the number, the arrangement, the magnetic field intensity, the length in the center axis direction and the distance from the center of the segmental magnet 32, and also positions from the wafer 13 in the center axis direction of respective dipole ring magnets 30a, 30b and so forth, it is possible to consider various constitution of these elements in response to a need as it arises. Thus, various constitutions by these elements make it possible to form various distributions of the magnetic field.

FIG. 3 shows an example of the distribution of the magnetic field. In this figure, dotted lines following respective arrow heads indicate magnetic lines of force 45. FIG. 3 shows an example in which the length in the direction of the center axis of the segmental magnet 32 in the dipole ring magnet 30a is made longer than that of the segmental magnet 32 in the dipole ring magnet 30b. Now, let the magnetic field angle θ be an angle at which the magnetic line of force 45 intersects the surface of the wafer 13 at the edge portion thereof, and it can be determined by the distribution of the magnetic field and the relative position between the magnetic line of force and the wafer. Accordingly, it is possible to change the magnetic field angle θ by altering the distribution of the magnetic field. However, the magnetic field angle θ can be more easily changed by changing the wafer position in the direction of the center axis without changing the distribution of the magnetic field.

The etching treatment by means of etching apparatus as described above is carried out as follows. First of all, the reactive gas supplied from the reactive gas supply system 22 is introduced to the space between the lower side electrode 11 and the upper side electrode 12. The electric power is applied between the lower side electrode 11 and the upper side electrode 12 by the high frequency power source 14, thereby making a high frequency alternating electric field generate in the direction perpendicularly intersecting the surface of the wafer 13 between the lower side electrode 11 and the upper side electrode 12. In FIGS. 2 and 3, the arrow mark 44 indicates the direction of the electric field at a certain moment it has been generated between the lower side electrode 11 and the upper side electrode 12. With this electric discharge, the reactive gas comes to enter in the plasma state while in the space between rings of dipole ring magnets 30a, 30b, the magnetic field is generated in the direction as shown by the arrow mark 43 in FIG. 2 as well as by the magnetic lines of force in FIG. 3, thereby the high density plasma being generated by interaction of these electric field and the magnetic field. Ions in the plasma are accelerated by the electric field induced on the surface of wafer 13 to strike the wafer, thereby etching being executed.

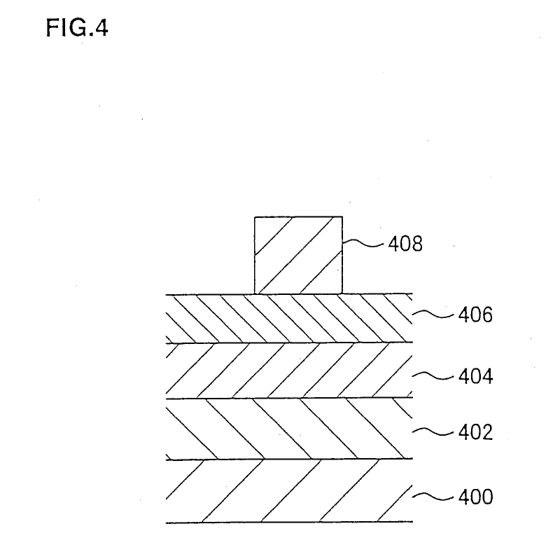

In the next, there will be described a concrete example using the method of etching stacked-film layer according to the embodiment of the invention. FIG. 4 is an illustration showing the structure of the sample of the substrate to be etched. The hard mask film 402 and the second hard mask film 404 are stacked in sequence on the lower layer film 400. Furthermore, an antireflection film 406 is stacked on the second hard mask film 404, and a photo resist film having a predetermined pattern shape is stacked on the above antireflection film 406. The constitution of the above each film is as follows. The lower layer film 400 is made of tungsten (W), and the first hard mask film 402 is made of SiN and has a thickness of 200 nm. The second hard mask 404 is made of SiO₂ and has a thickness of 50 nm. The antireflection film 406 is made of an organic material and has a thickness of 80 nm. The photo resist film 408 has a thickness of 460 nm.

The antireflection film 406 of the sample having the structure as described above is etched according to the treatment condition 2 as described below while the second hard mask 404 is etched according to the treatment condition 3 as under-mentioned. Etching of the first hard mask film 402 and over-etching are carried out according to the treatment condition 4 as described below.

The change of the treatment condition from one to the other is carried out by affirming completion of the etching of each film based on the plasma light emission. To put it more concretely, completion of the etching of the antireflection film 406 is affirmed by detecting the point of time at which the intensity of the light (wavelength: 440.1 nm) emitted by SiF begins to increase, SiF being a compound produced by chemical reaction between the lower layer film 400 and the etching gas. Furthermore, completion of the etching of the second hard mask film 404 is confirmed by detecting the point of time at which the intensity of the light (wavelength: 387.2 nm) emitted by CN begins to increase, CN being a compound produced by chemical reaction between the lower layer film 400 and the etching gas. Still further, completion of the etching of the first hard mask film 402 is made sure by detecting the point of time at which the intensity of the light (wavelength: 387.2 nm) emitted by CN begins to decrease.

As shown in the various treatment conditions as described below, the magnetic field angle θ is set corresponding to the sort of the film. That is, the SiO₂ layer is etched by setting the magnetic field angle θ at 4.93°, and the SiN layer is etched by setting the magnetic field angle θ at 12.88°. The change of the magnetic field angle θ is carried out by operating the driving mechanism 28 to move the dipole ring magnets 30a, 30b in the direction of the center axis. The relation between the dipole ring magnets 30a, 30b and the magnetic field angle θ is obtained in advance based on the data with respect to the magnetic force, dimension, layout and others of the anisotropic segmental magnets 32 of the dipole ring magnets 30a, 30b. The value of the magnetic field angle θ as set for each of the above SiO₂ and SiN films as well is the optimum values determined from the results of experiments on each of the above films. The electric power from the high frequency power source 14 is cut off while the dipole ring magnets 30a, 30b are moved.

[Treatment Condition 2]

Magnetic field angle θ: 12.88°

High frequency power source: 1000 W

Gap between electrodes: 40 mm

Etching gas: CF₄/Ar=120/480 sccm

Pressure inside processing chamber: 150 mTorr

Susceptor temperature: 60° C.

[Treatment Condition 3]

Magnetic field angle θ: 4.93°

High frequency power source: 1200 W

Gap between electrodes: 40 mm

Etching gas: CHF₃/CF₄/Ar/O₂=12/72/480/12 sccm

Pressure inside processing chamber: 200 mTorr

Susceptor temperature: 60° C.

[Treatment Condition 4]

Magnetic field angle θ: 12.88°

High frequency power source: 1000 W

Gap between electrodes: 40 mm

Etching gas: CHF₃/CF₄/Ar/O₂=30/75/650/15 sccm

Pressure inside processing chamber: 150 mTorr

Susceptor temperature: 60° C.

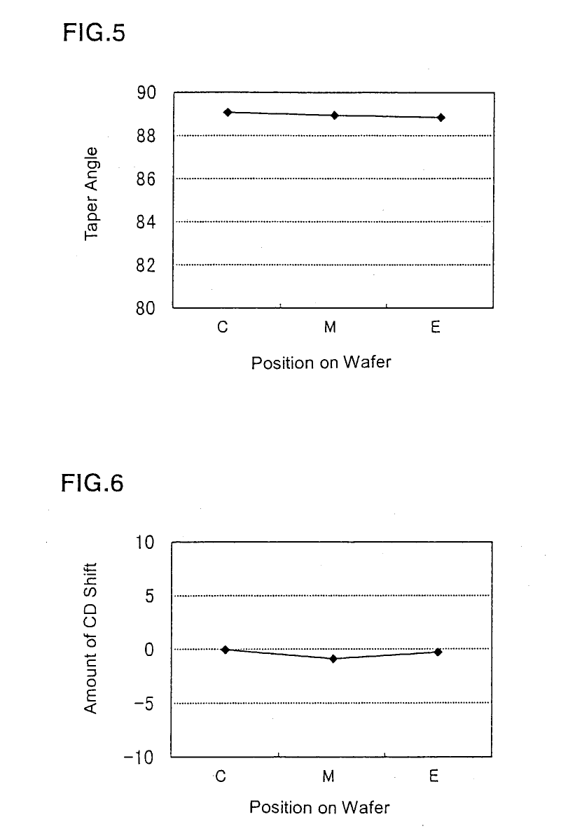

FIGS. 5 and 6 are graphs showing characteristics of the surface etching of the wafer after treating it under the treatment conditions as described above. In these graphs, the abscissa indicates the position on the wafer and alphabets C, E and M indicates the center, the edge, and the middle part between the center and the edge of the wafer, respectively. The ordinate of the graph in FIG. 5 indicates the taper angle while the ordinate of the graph in FIG. 6 indicates the critical dimension (CD) shift amount, which represents the width difference between the top and the bottom of a pattern line. In FIG. 6, let the CD shift amount at the center C be zero as a standard and respective CD shift amounts at E and M are indicated as the deviation (difference) from the standard i.e. zero. As will be seen form graphs of FIGS. 5 and 6, the values of the ordinate at each point of C, M and E are almost constant and it can be understood that the good etching uniformity is obtained.

In the next, for comparison, there will be explained about the etching of the sample by means of the prior art etching method. The film constitution of the sample as used in this comparison is as follows. The lower layer 400 is made of WSi. The first hard mask film 402 is made of SiO₂ and has a thickness of 70 nm and the second hard mask film 404 is made of SiN and has s thickness of 70 nm. The antireflection film 404 is SiON and has a thickness of 50 nm and the photo resist film 408 has a thickness of 445 nm.

The main etching of the antireflection film 406, the second hard mask film 404 and the first hard mask film 402 is carried out under the treatment condition 5 as mentioned below and the over-etching thereof is carried out under the treatment condition 6 as described below. At this time, the magnetic field angle θ is kept at a constant value of 12.88° all the way of the etching process.

[Treatment Condition 5]

High frequency power source: 1200 W

Gap between electrodes: 40 mm

Etching gas: CHF₃/CF₄/Ar/O₂=20/50/400/10 sccm

Pressure inside processing chamber: 125 mTorr

Susceptor temperature: 60° C.

[Treatment Condition 6]

High frequency power source: 3200 W

Gap between electrodes: 40 mm

Etching gas: CHF₃/Ar=16/800 sccm

Pressure inside processing chamber: 50 mTorr

Susceptor temperature: 60° C.

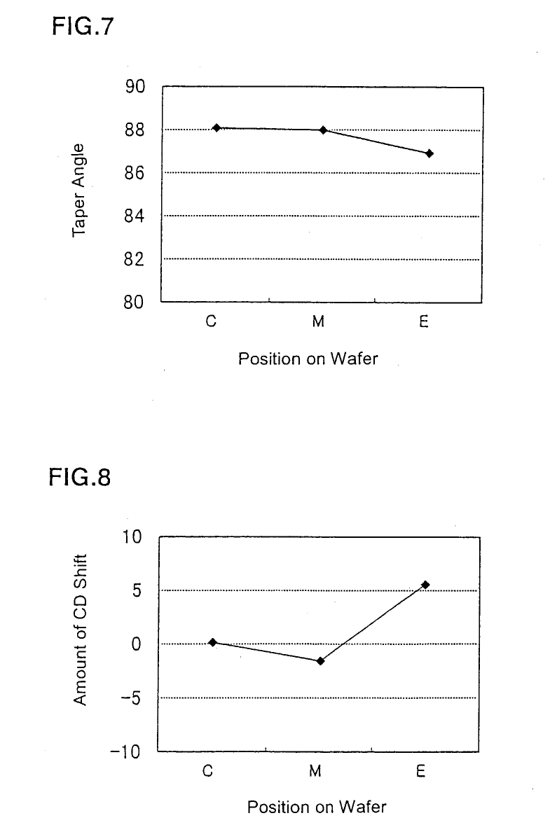

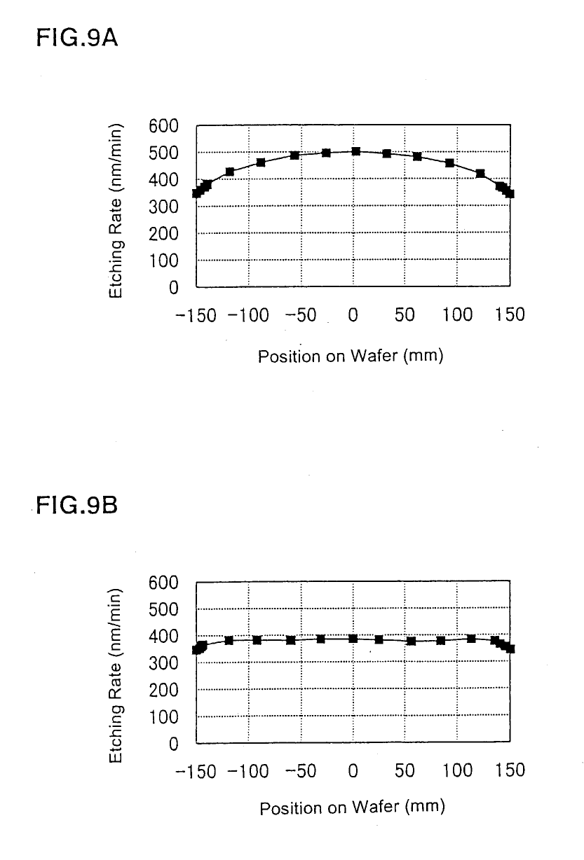

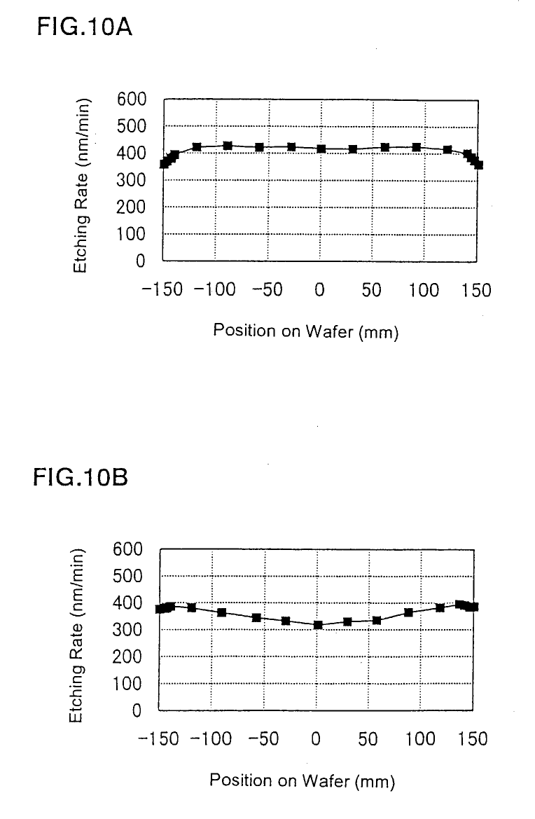

FIGS. 7 and 8 are graphs showing characteristics of the surface etching of the wafer after treating it under the treatment condition as mentioned above. The abscissa and ordinate of these graphs represent the same things as those of graphs in FIGS. 5 and 6, respectively. In FIG. 8, similar to FIG. 6, the CD shift amount at the center C is made to be zero as a standard and respective CD shift amounts at edge E and the middle portion M are indicated as the deviation (difference) from the standard i.e. zero. As will be seen form the graph of FIG. 7, the value of the taper angle at the edge E becomes smaller than those at the center C and the middle portion M. On one hand, it will be seen from the graph of FIG. 8 that the dispersion of the CD shift amount at the middle portion M and the edge E is larger than those as shown in FIG. 6, especially at the edge E, the CD shift amount becomes larger than those at the center C and middle portion M. As a whole, there is seen a tendency that the dispersion of the taper angle and the CD shift amount at each position becomes larger in comparison with those which are shown in FIGS. 5 and 6. That is, the etching uniformity in the wafer surface can not be in the acceptable level.

Accordingly, it will be understood that when etching a stacked-film layer composed of a plurality of films made of different materials, the good etching uniformity in the wafer surface can be realized by etching the stacked-film layer at the magnetic field angle θ as suitably changed corresponding to the quality of the material of each film constituting the stacked-film layer.

While preferred embodiments of the invention have been shown and described with reference to the accompanying drawings, it is needless to say that the invention should not be limited by these examples. It will be apparent to those skilled in the art that various changes and modifications can be made without departing from the principle and spirit of the invention, the scope of which is defined in the appended claims, and it is understood that those changes and modifications belong to the technical scope of the invention.

In the above description, the plasma etching apparatus as shown in FIG. 1 has been explained as an example of the apparatus capable of practicing the etching method according to the embodiment of the invention, but the invention is not limited to the above example. For instance, means for generating the magnetic field is able to have other constitution than that of the example, and the invention is applicable to the substrate other than the above-mentioned sample.

Also, the embodiment according to the invention has been explained in connection with the case where the photo resist layer formed in the shape of a predetermined pattern is used as a mask when etching a multi-layered mask made up of two inorganic layers, that is, SiO2 layer and SiN layer. The invention is not limited to this but is applicable to the case where the above photo resist layer is used as a mask when etching a multi-layered mask made up of an inorganic material film and an organic material film. In this case, there is no need for the material of the organic material film to be photosensitive. Furthermore, it is possible to use the material including the carbon C and hydrogen H and also the material including the oxygen O in addition to C and H. The material frequently selected for use in the foundation layer to be etched preferably contains carbon at a high percentage.

As has been discussed above, according to the invention, if the stacked-film layer is etched by using the magnetron plasma etching method, it becomes possible to obtain good etching uniformity with regard to every film as etched.

What is claimed is:

1. A method of etching a stacked-film layer formed on a substrate and including a plurality of films made of materials having different qualities comprising the steps of:
generating such a magnetic field that makes a predetermined angle to the edge portion of said substrate mounted inside a processing chamber and is approximately in parallel with the surface of said substrate at the center portion thereof;
applying a high frequency electric power for generating plasma to an electrode provided inside said processing chamber so as to generate a high frequency alternating electric field in the direction intersecting the surface of said substrate approximately at right angles, thereby making plasma of an etching gas introduced in said processing chamber and etching said stacked-film layer with said plasma; and
setting said predetermined magnetic field angle to every sort of the film to be etched.

2. A method of etching as claimed in claim 1, wherein said etching is carried out in the same processing chamber without taking out said substrate.

3. A method of etching as claimed in claim 1, wherein at least two films included in said stacked-film layer are etched with the same sort of gas.

4. A method of etching as claimed in claim 1, wherein said predetermined angle of said magnetic field is in the range of 3° through 15°.

5. A method of etching as claimed in claim 2, wherein the power supply from said high frequency power source is cut off while said predetermined angle of said magnetic field is being changed.

6. A method of etching as claimed in claim 1, wherein said stacked-film layer includes any one of at least silicon oxide film, silicon nitride film or silicon oxide-nitride film.

7. A method of etching as claimed in claim 6, wherein said stacked-film layer further includes a film made of an organic material.

8. A method of etching as claimed in claim 7, wherein said stacked-film layer serves as a mask layer to said foundation layer while said foundation layer is etched.

9. Apparatus for etching a stacked-film layer formed on a substrate and including a plurality of films made of materials having different qualities comprising:
means for generating such a magnetic field that makes a predetermined angle to the edge portion of said substrate mounted inside a processing chamber and is approximately in parallel with the surface of said substrate at the center portion thereof;
means for applying a high frequency electric power for generating plasma to an electrode provided inside said processing chamber so as to generate a high frequency alternating electric field in the direction intersecting the surface of said substrate approximately at right angles, thereby making plasma of an etching gas introduced in said processing chamber and etching said stacked-film layer with said plasma; and
means for setting said predetermined magnetic field angle to every sort of the film to be etched.

10. Apparatus of etching as claimed in claim 9, wherein said etching is carried out in the same processing chamber without taking out said substrate.

11. Apparatus of etching as claimed in claim 9, wherein at least two films included in said stacked-film layer are etched with the same sort of gas.

12. Apparatus of etching as claimed in claim 9, wherein said predetermined angle of said magnetic field is in the range of 3° through 15°.

13. Apparatus of etching as claimed in claim 10, wherein the power supply from said high frequency power source is cut off while said predetermined angle of said magnetic field is being changed.

14. Apparatus of etching as claimed in claim 9, wherein said stacked-film layer includes any one of at least silicon oxide film, silicon nitride film or silicon oxide-nitride film.

15. Apparatus of etching as claimed in claim 14, wherein said stacked-film layer further includes a film made of an organic material.

16. Apparatus of etching as claimed in claim 15, wherein said stacked-film layer serves as a mask layer to the said foundation layer while said foundation layer is etched.
